(19) United States
(12) Patent Application Publication
(10) Pub. No.: US 2021/0373119 A1
(43) Pub. Date: Dec. 2, 2021

(54) CONTROL DEVICE AND NON-TRANSITORY STORAGE MEDIUM

(71) Applicant: KABUSHIKI KAISHA TOKAI RIKA DENKI SEISAKUSHO, Aichi (JP)

(72) Inventors: Yosuke OHASHI, Aichi (JP); Masateru FURUTA, Aichi (JP); Yuki KONO, Aichi (JP); Shigenori NITTA, Aichi (JP)

(73) Assignee: KABUSHIKI KAISHA TOKAI RIKA DENKI SEISAKUSHO, Aichi (JP)

(21) Appl. No.: 17/230,471

(22) Filed: Apr. 14, 2021

(30) Foreign Application Priority Data
May 26, 2020 (JP) 2020-091274

(51) Int. Cl. G01S 5/14; H04W 4/02; G01S 5/00; H04W 4/40

(52) U.S. Cl. CPC G01S 5/14; H04W 4/40; G01S 5/0072; H04W 4/023

(57) ABSTRACT

To measure the distance between the devices with higher accuracy.

There is provided a control device comprising a control section configured to control a ranging process of measuring a distance between communication devices, wherein the control section causes the ranging process to be executed more than once, and controls a subsequent process on a basis of a representative value of a plurality of ranging values that have been acquired, the subsequent process being a process using the representative value.

### CROSS REFERENCE TO RELATED APPLICATION(S)

This application is based upon and claims benefit of priority from Japanese Patent Application No. 2020-091274, filed on May 26, 2020, the entire contents of which are incorporated herein by reference.

### BACKGROUND

The present invention relates to a control device and a non-transitory storage medium.

In recent years, technologies of measuring a distance between devices in accordance with a result of transmitting/receiving signals between the devices have been developed. For example, JP 2018-48821A discloses a technology of measuring a distance between an in-vehicle device and a portable device by transmitting/receiving signals between the in-vehicle device and the portable device.

### SUMMARY

Meanwhile, in the case of performing the ranging process based on transmission and reception of the signals as described above, it is necessary to measure the distance between the devices with higher accuracy.

Accordingly, the present invention is made in view of the aforementioned issue, and an object of the present invention is to provide a mechanism that makes it possible to measure a distance between devices with higher accuracy.

To solve the above described problem, according to an aspect of the present invention, there is provided a control device comprising a control section configured to control a ranging process of measuring a distance between communication devices, wherein the control section causes the ranging process to be executed more than once, and controls a subsequent process on a basis of a representative value of a plurality of ranging values that have been acquired, the subsequent process being a process using the representative value.

To solve the above described problem, according to another aspect of the present invention, there is provided a non-transitory storage medium having a program stored therein, the program causing a computer to function as a control section configured to control a ranging process of measuring a distance between communication devices, wherein the program causes the control section to execute the ranging process more than once, and control a subsequent process on a basis of a representative value of a plurality of ranging values that have been acquired, the subsequent process using the representative value.

As described above, according to the present invention, it is possible to provide the mechanism that makes it possible to measure a distance between devices with higher accuracy.

### BRIEF DESCRIPTION OF THE DRAWINGS

FIG. 1 is a diagram illustrating a configuration example of a system according to an embodiment of the present invention.

FIG. 2 is a sequence diagram illustrating an example of a flow of a process executed by the system according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

<<1.1. Overview>>

First, an overview of an embodiment of the present invention will be described. As described above, in recent years, technologies of performing authentication in accordance with a result of transmitting/receiving signals between devices have been developed. For example, JP 2018-48821A discloses a technology of authenticating a portable device by transmitting/receiving signals between an in-vehicle device and the portable device. By using such an authentication technology, for example, it is possible to achieve a function of unlocking a door lock of a vehicle, a function of starting an engine, and other functions when a distance between the vehicle and the portable device carried by the user comes within a distance enabling communication.

However, for example, in the case of performing authentication between devices through request response authentication using ultra high frequency (UHF) or low frequency (LF), a relay may be used to relay a transmission signal of an in-vehicle device, and communication may be indirectly established between a portable device (authenticatee) and the in-vehicle device. This may result in concerns about a relay attack. The relay attack may improperly establish authentication between the in-vehicle device and the portable device. Here, the request response authentication is a method in which an authenticator generates an authentication request and transmits the generated authentication request to an authenticatee, the authenticatee generates an authentication response on the basis of the authentication request and transmits the generated authentication response to the authenticator, and the authenticator authenticates the authenticatee on the basis of the authentication response. Accordingly, a mechanism capable of preventing authenticatee spoofing such as the above-described relay attack and further improving authentication accuracy has been desired.

Therefore, for example, in addition to or instead of the inter-device authentication using the request response authentication, it is also envisaged that the inter-device authentication may be performed on the basis of a ranging value acquired through a ranging process between devices. By using such an authentication process, it is possible to perform authentication in view of a value indicating a precise distance between the devices, and it is possible to improve security.

On the other hand, accuracy of the ranging process based on transmission and reception of signals is affected by various kinds of factors. For example, there is a possibility that communication is not established on the first try in the case where an integrated circuit included in the device has low sensitivity or in the case where a signal used for the communication is easily affected by an obstacle. In addition, in an environment where multipath easily occurs, propagation time of a signal that is transmitted from a source, reflected by another object, and then reaches a receiver is longer than propagation time of a signal that is transmitted from the source and then directly reaches the receiver. The multipath is a phenomenon where a single source transmits a signal but a receiver receives a plurality of signals. Therefore, there is a possibility that an acquired ranging value may be larger than an actual distance between devices in the case where the ranging process is executed on the basis of a signal that has been reflected by another object and then has reached a receiver as described above. Accordingly, in the case where such a ranging process is executed more than once, it is envisaged that there may be an error (variation) in acquired ranging values.

The technical idea of the present invention was conceived by focusing on the above-described points. The technical idea of the present invention makes it possible to effectively eliminate the above-described error and measure the distance between the devices with higher accuracy. Therefore, a control device according to an embodiment of the present invention includes a control section configured to control a ranging process of measuring a distance between communication devices. In addition, one of features of the control section is to cause the ranging process to be executed between the communication devices more than once, and control a subsequent process on the basis of a representative value of a plurality of ranging values that have been acquired. The subsequent process is a process using the representative value.

In other words, through the ranging method according to the present embodiment, the ranging process is performed more than once and the plurality of ranging values are acquired. This makes it possible to effectively eliminate the above-described errors caused by the IC, signal characteristics, multipath, or the like, and use a highly accurate ranging value acquired as the representative value, for the subsequent process. Therefore, by using the control device according to the embodiment of the present invention, it is possible to drastically improve functionality of various kinds of devices for performing the subsequent process that emphasizes accuracy of ranging values. Next, details of a configuration example of the system according to the present embodiment will be described.

<<1.2. Configuration Example>>

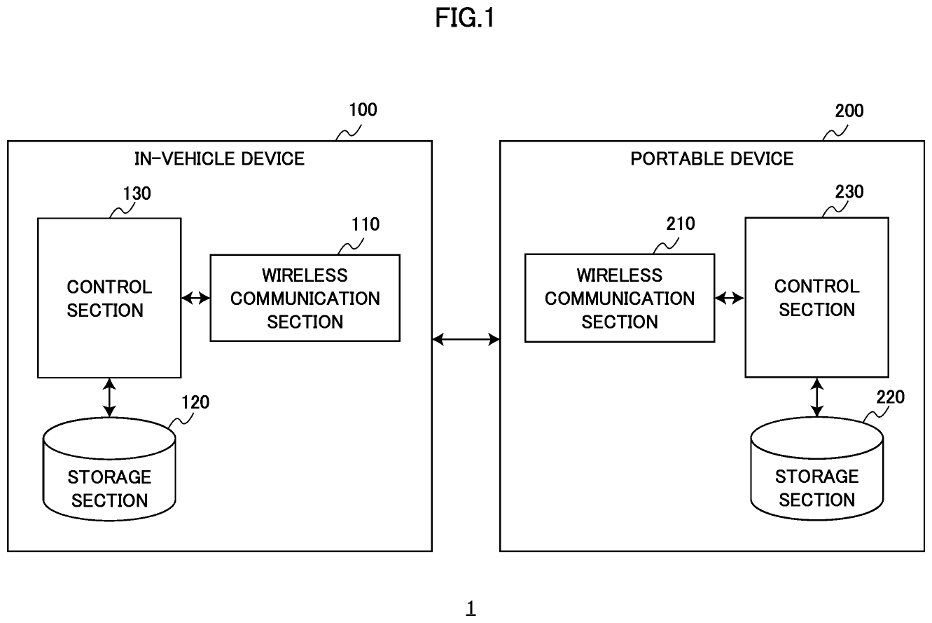

FIG. 1 is a diagram illustrating a configuration example of a system 1 according to the embodiment of the present invention. As illustrated in FIG. 1, the system 1 according to the present embodiment includes an in-vehicle device 100 and a portable device 200. The in-vehicle device 100 and the portable device 200 are examples of communication devices according to the present embodiment. In addition, the system 1 according to the present embodiment includes a control device that controls a ranging process to be performed between the communication devices. For example, the control device according to the present embodiment may be prepared in a same casing as one of the communication devices, or may be prepared as another casing such as a server. Hereinafter, a case where the control device according to the present embodiment is the in-vehicle device 100 will be described as a major example. In this case, the in-vehicle device 100 functions as the control device and the communication device.

In addition, hereinafter, a case where various kinds of subsequent processes related to a vehicle provided with the in-vehicle device 100 are controlled on the basis of a representative value obtained through the ranging process performed between the in-vehicle device 100 and the portable device 200, will be described as a major example.

(In-Vehicle Device 100)

The in-vehicle device 100 is an example of the control device according to the present embodiment, and an example of the communication device. The in-vehicle device 100 is installed in a vehicle that allows a user to get in (for example, a vehicle owned by the user or a vehicle temporarily rented by the user). As illustrated in FIG. 1, the in-vehicle device 100 includes a wireless communication section 110, a storage section 120, and a control section 130.

The wireless communication section 110 performs communication with the portable device 200 in conformity with a designated wireless communication standard under the control of the control section 130. Examples of the designated wireless communication standard include a wireless communication standard using ultra-wideband (UWB) (hereinafter, this standard will also be simply referred to as UWB). The UWB uses only short pulses. Therefore, the UWB consumes low electric power. In addition, the UWB does not use complicated modulation/demodulation schemes, and this is advantageous to reduction in cost. In addition, the UWB uses pulses of nanosecond order. This makes it possible to measure arrival time of a signal with high accuracy and perform ranging and positioning with high accuracy.

The storage section 120 has a function of storing various kinds of information related to operation of the in-vehicle device 100. For example, the storage section 120 stores a program for operating the in-vehicle device 100, identification information such as an identifier (ID), key information such as a password, an authentication algorithm, or the like. For example, the storage section 120 includes a storage medium such as flash memory and a processing device that performs recording/playback on/of the storage medium.

The control section 130 controls respective operation of structural elements included in the in-vehicle device 100. In addition, the control section 130 controls communication between the wireless communication section 110 and a wireless communication section 210 of the portable device 200, a ranging process based on the communication, and a subsequent process using a result of the ranging process. In this case, one of features of the control section 130 according to the present embodiment is to cause the ranging process to be executed more than once, and control the subsequent process on the basis of a representative value of a plurality of ranging values that have been acquired. The subsequent process is a process using the representative value. Such control makes it possible to measure the distance between the communication devices with higher accuracy, and makes it possible to drastically improve functionality of various kinds of devices for performing the subsequent process that emphasizes accuracy of the ranging values. For example, the control section 130 includes an electronic circuit such as a central processing unit (CPU) or a microprocessor.

(Portable Device 200)

The portable device 200 is an example of the communication device according to the present embodiment. The portable device 200 may be any device to be carried by the user, such as an electronic key, a smartphone, or a wearable terminal. As illustrated in FIG. 1, the portable device 200 includes the wireless communication section 210, a storage section 220, and a control section 230.

The wireless communication section 210 has a function of performing communication with the in-vehicle device 100 in conformity with the designated wireless communication standard.

The storage section 220 has a function of storing various kinds of information related to operation of the portable device 200. For example, the storage section 220 stores a program for operating the portable device 200, identification information such as an ID, key information such as a password, an authentication algorithm, or the like. For example, the storage section 220 includes a storage medium such as flash memory and a processing device that performs recording/playback on/of the storage medium.

The control section 230 controls structural elements included in the portable device 200. For example, the control section 230 controls the wireless communication section 210, communicates with the in-vehicle device 100, reads information from the storage section 220, and writes information into the storage section 220. For example, the control section 230 includes an electronic circuit such as a CPU or a microprocessor.

The configuration example of the system 1 according to the present embodiment has been described above. Note that, the configuration described above with reference to FIG. 1 is a mere example. The configuration of the system 1 according to the present embodiment is not limited thereto. The case where the control section 130 of the in-vehicle device 100 controls the ranging process and the subsequent process has been described above as the example. However, the above-described functions may be achieved as functions of the control section 230 of the portable device 200, the server that is separately prepared from the portable device 200, or the like. The configuration of the system 1 according to the present embodiment may be flexibly modified in accordance with specifications and operations.

<<1.3. Details>>

Next, details of the ranging process and the subsequent process will be described. The ranging process is performed by the system 1 according to the present embodiment. The subsequent process is a process using the representative value acquired through the ranging processes. As described above, the wireless communication section 110 of the in-vehicle device 100 and the wireless communication section 210 of the portable device 200 according to the present embodiment perform communication in conformity with the designated wireless communication standard such as the UWB, for example. In general, by using the UWB, it is possible to perform ranging and positioning with high accuracy. However, one of the features of the UWB is to be easily affected by an obstacle, multipath, or the like.

Therefore, the control section 130 according to the present embodiment may cause the ranging process to be executed more than once, and control the subsequent process on the basis of the representative value of the plurality of ranging values that have been acquired. The subsequent process is the process using the representative value. Such control makes it possible to control the subsequent process on the basis of the ranging value (representative value) from which influence of the obstacle and influence of the multipath are removed, even in the case where the communication is not established on the first try due to the influence of the obstacle or in the case where an acquired ranging value is longer than an actual distance due to the influence of the multipath, for example.

More specifically, the control section 130 according to the present embodiment may determine whether or not the above-described representative value satisfies a designated allowable value and determine executability of the subsequent process.

For example, the control section 130 determines whether or not the acquired representative value exceeds the designated allowable value. Here, in the case where the representative value exceeds the designated allowable value, the control section 130 does not have to execute the subsequent process. Such control makes it possible to precisely control the functions in accordance with the distance between the communication devices.

Note that, the designated allowable value may be appropriately set in accordance with specifications or the like. For example, the designated allowable value may be 5 meters or 3 meters. Alternatively, the designated allowable value is not limited to the above-described examples, but may be another value.

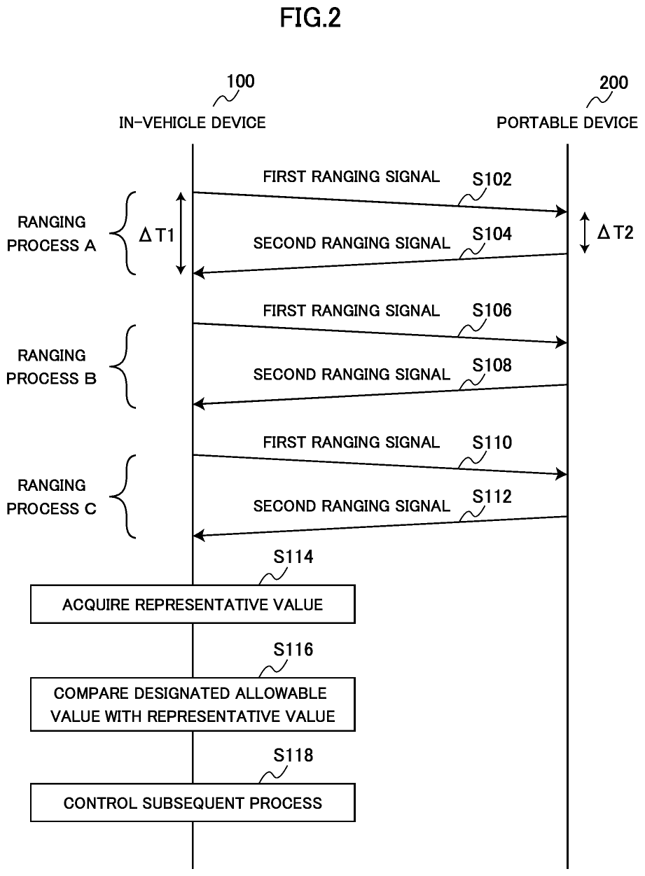

Next, with reference to FIG. 2, a detailed example of a flow of the process executed by the system 1 according to the present embodiment will be described. FIG. 2 is a sequence diagram illustrating the example of the flow of the process executed by the system 1 according to the present embodiment. Note that, FIG. 2 illustrates the in-vehicle device 100 as an example of the control device and the communication device, and illustrates the portable device 200 as an example of the communication device. In addition, FIG. 2 illustrates an example of a case where the in-vehicle device 100 and the portable device 200 perform the ranging process using the UWB.

First, the control section 130 controls execution of the ranging process between the in-vehicle device 100 and the portable device 200. The ranging process according to the present embodiment includes transmission of a first ranging signal from one of the communication devices to another communication device, transmission of a second ranging signal from the other communication device in response to the first ranging signal, and calculation of a ranging value on the basis of time it takes to transmit and receive the first ranging signal and the second ranging signal.

For example, as illustrated in FIG. 2, the control section 130 causes the wireless communication section 110 of the in-vehicle device 100 to transmit the first ranging signal (Step S102), and to receive the second ranging signal that the wireless communication section 210 of the portable device 200 transmits in response to the first ranging signal (Step S104).

At this time, the ranging value indicating the distance between the in-vehicle device 100 and the portable device 200 is calculated from a time period ΔT1 from time when the wireless communication section 110 of the in-vehicle device 100 transmits the first ranging signal in Step S102 to time when the wireless communication section 110 of the in-vehicle device 100 receives the second ranging signal in Step S104, and a time period ΔT2 from time when the wireless communication section 210 of the portable device 200 receives the first ranging signal in Step S102 to time when the wireless communication section 210 of the portable device 200 transmits the second ranging signal in Step S104.

More specifically, time taken to perform two-way communication of the ranging signals is calculated by subtracting ΔT2 from ΔT1, and time taken to perform one-way communication of the ranging signal is calculated by dividing the calculated time by 2. In addition, by multiplying the value obtained through (ΔT1−ΔT2)/2 by speed of the signal, it is possible to calculate the ranging value indicating the distance between the in-vehicle device 100 and the portable device 200.

Therefore, for example, in the case where the portable device 200 transmits the second ranging signal including the ΔT2 value, the in-vehicle device 100 can calculate the ranging value from the ΔT2 value included in the received second ranging signal and the ΔT1 value calculated by the in-vehicle device 100 itself.

One of features of the control section 130 according to the present embodiment is to cause the above-described ranging process to be executed more than once. For example, in the case of the example illustrated in FIG. 2, the control section 130 controls execution of three ranging processes A to C. The ranging process A is a process including transmission/reception of the first ranging signal in Step S102, transmission/reception of the second ranging signal in Step S104, and calculation of the ranging value based on the both signals. The ranging process B is a process including transmission/reception of the first ranging signal in Step S106, transmission/reception of the second ranging signal in Step S108, and calculation of the ranging value based on the both signals. In addition, the ranging process C is a process including transmission/reception of the first ranging signal in Step S110, transmission/reception of the second ranging signal in Step S112, and calculation of the ranging value based on the both signals.

Next, the control section 130 according to the present embodiment acquires a representative value of the plurality of ranging values (ranging values a to c) acquired through the respective ranging processes A to C (Step S114). The representative value according to the present embodiment may be a value indicating a reasonable distance between the communication devices, which is envisaged on the basis of the plurality of ranging values that have been acquired.

For example, in the case of communication using the UWB, signal propagation speed is close to the speed of light. Therefore, it is envisaged that the ranging value does not drastically fall below an actual distance between the communication devices. Accordingly, as the representative value, the control section 130 according to the present embodiment may use a smallest ranging value among the plurality of ranging values a to c that have been acquired.

Alternatively, for example, the control section 130 according to the present embodiment may use an average value, a median, a mode, or the like of the ranging values a to c, as the representative value. In this case, it is also possible to effectively reduce the influence of the obstacle or multipath, and measure the distance between the communication devices more accurately. Note that, a method of calculating the representative value is not limited to the above-described methods. The method of calculating the representative value may be a method of removing singular values from all the ranging values that have been measured, and calculating an average value, a median, a mode, or the like of the ranging values from which the singular values are removed, as the representative value.

In addition, as the representative value, the control section 130 may use a value that is identical to the designated allowable value, in the case where the subsequent process, which is the process using the representative value, does not need a precise distance value and any of the ranging values a to c satisfies the designated allowable value, for example.

Next, the control section 130 according to the present embodiment compares the designated allowable value with the representative value acquired in Step S114 (Step S116), and controls the subsequent process on the basis of whether or not the representative value satisfies the designated allowable value (Step S118). More specifically, in the case where the representative value does not satisfy the designated allowable value, the control section 130 may end the process without executing the subsequent process. On the other hand, in the case where the representative value satisfies the designated allowable value, the control section 130 performs control in such a manner that the subsequent process is executed.

For example, the subsequent process according to the present embodiment may be an unlocking process, which is a process of unlocking a lock device installed in an open/close mechanism. Examples of the open/close mechanism include a door of the vehicle provided with the in-vehicle device 100. In the case where the representative value is the designated allowable value, that is, in the case where a distance between the in-vehicle device 100 and the portable device 200 is a designated distance or less, the control section 130 according to the present embodiment may perform control in such a manner that the door of the vehicle is unlocked. Note that, the open/close mechanism according to the present embodiment is not limited to the door of the vehicle, but may be various kinds of doors installed in buildings such as a house, rockers, delivery lockers, or the like.

In addition, for example, the subsequent process according to the present embodiment may be an activation process of activating a predetermined device. Examples of the predetermined device include an engine of the vehicle provided with the in-vehicle device 100. In the case where the representative value satisfies the designated allowable value, that is, in the case where the distance between the in-vehicle device 100 and the portable device 200 is the designated distance or less, the control section 130 according to the present embodiment may perform control in such a manner that the activation process of the engine of the vehicle is executable.

Note that, the control section 130 according to the present embodiment may also control a plurality of subsequent processes such as the unlocking process and the activation process. In addition, in this case, it is also possible for the control section 130 to perform control on the basis of designated allowable values that vary among different subsequent processes. For example, the control section 130 can unlock the door of the vehicle provided with the in-vehicle device 100 in the case where the distance between the in-vehicle device 100 and the portable device 200 becomes 10 meters or less, and the control section 130 can perform control in such a manner that the activation process of the engine is executable in the case where the distance becomes 1 meter or less.

### <2 Conclusion>

As described above, the control device according to the embodiment of the present invention includes the control section configured to control the ranging process of measuring a distance between the communication devices. In addition, one of features of the control section is to cause the ranging process to be executed more than once, and control the subsequent process, which is the process using the representative value of the plurality of ranging values that have been acquired. Such a configuration makes it possible to measure the distance between the devices with higher accuracy.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, in the above-described embodiment, the case where the in-vehicle device 100 transmits the first ranging signal and the portable device 200 transmits the second ranging signal in response to the first ranging signal has been described as an example. However, it is also possible that the portable device 200 transmits the first ranging signal and the in-vehicle device 100 transmits the second ranging signal. In this case, the in-vehicle device serving as the control device may find a representative value by receiving a plurality of ranging values that the portable device 200 have calculated, or may find a ranging value and a representative value by receiving the ΔT1 value from the portable device 200.

In addition, the control device does not have to be implemented as the in-vehicle device 100. The control device may be implemented as the portable device 200, or may be prepared in a separate casing such as the server. In addition, the present invention is not limited to the vehicle control, but is applicable to any system that performs the ranging process and the subsequent process by transmitting/receiving signals. For example, the present invention is widely applicable to a ranging process and subsequent processes, which are related to mobile objects including a drone or the like, buildings such as a house, home appliances, or the like.

In addition, in the above embodiment, the UWB has been exemplified as the designated wireless communication standard. However, the wireless communication standard according to the present invention is not limited thereto. Any standard that enables the ranging process based on transmission/reception of signals may be adopted as the wireless communication standard according to the present invention. The any standard described herein includes signal communication using BLE, signal communication using Zigbee, signal communication using Wi-Fi, and the like.

In addition, in the above-described embodiment, the case where executability of the subsequent process is determined based only on whether or not the acquired representative value satisfies the designated allowable value has been described as an example. However, it is also possible for the control device according to the present invention to use a result of another authentication process to determine executability of the subsequent process. Examples of the authentication process include the request response authentication described above.

Note that, the series of processes performed by the devices described in this specification may be achieved by any of software, hardware, and a combination of software and hardware. A program that configures the software is stored in advance in, for example, a recording medium (non-transitory medium) installed inside or outside the devices. In addition, for example, when a computer executes the programs, the programs are read into RAM, and executed by a processor such as a CPU. The recording medium may be a magnetic disk, an optical disc, a magneto-optical disc, flash memory, or the like, for example. Alternatively, the above-described computer program may be distributed via a network without using the recording medium, for example.

Further, the processes described in the present specification by using the sequence diagram are not necessarily executed in the order illustrated in the drawing. Some processing steps may be executed in parallel. In addition, additional processing steps may be employed and some processing steps may be omitted.

What is claimed is:

1. A control device comprising
a control section configured to control a ranging process of measuring a distance between communication devices,
wherein the control section causes the ranging process to be executed more than once, and controls a subsequent process on a basis of a representative value of a plurality of ranging values that have been acquired, the subsequent process being a process using the representative value.

2. The control device according to claim 1,
wherein the control section determines executability of the subsequent process on a basis of whether or not the representative value satisfies a designated allowable value.

3. The control device according to claim 2,
wherein the control section does not execute the subsequent process in a case where the representative value does not satisfy the designated allowable value.

4. The control device according to claim 1,
wherein, as the representative value, the control section uses a smallest ranging value among the plurality of ranging values that have been acquired.

5. The control device according to claim 1,
wherein the ranging process include transmission of a first ranging signal from one of the communication devices to another communication device, transmission of a second ranging signal from the other communication device to the one communication device in response to the first ranging signal, and calculation of the ranging value on a basis of time it takes to transmit and receive the first ranging signal and the second ranging signal.

6. The control device according to claim 1,
wherein the ranging process includes a process of transmitting a first ranging signal and a second ranging signal through ultra-wideband wireless communication.

7. The control device according to claim 1,
wherein the subsequent process includes any of an unlocking process and an activation process, the unlocking process being a process of unlocking a lock device installed in an open/close mechanism including an openable/closable part, the activation process being a process of activating a predetermined device.

8. The control device according to claim 1,
wherein the ranging process includes a process of measuring a distance between a communication device installed in a vehicle and a communication device installed in a portable device.

9. A non-transitory storage medium having a program stored therein, the program causing a computer to function as a control section configured to control a ranging process of measuring a distance between communication devices,
wherein the program causes the control section to execute the ranging process more than once, and control a subsequent process on a basis of a representative value of a plurality of ranging values that have been acquired, the subsequent process using the representative value.
